(19) United States
(12) Patent Application Publication
(10) Pub. No.: US 2002/0088775 A1
(43) Pub. Date: Jul. 11, 2002

(54) High voltage disconnect switch

(76) Inventor: Ronald P. Bridges, Heber Springs, AR (US)

Correspondence Address: F. William McLaughlin, Wood, Phillips, VanSanten, Clark & Mortimer, Suite 3800, 500 West Madison Street, Chicago, IL, 60661-2511, US

(21) Appl. No.: 09/757,157

(22) Filed: Jan. 9, 2001

(51) Int. Cl. H01H 9/40

(52) U.S. Cl. 218/2

(57) ABSTRACT

A group operated circuit disconnect apparatus for overhead electrical power lines includes an operator controlling a plurality of disconnect switches. Each disconnect switch includes a vacuum circuit interrupter mounted inside an insulating bushing. Current is transferred from a terminal pad through the vacuum circuit interrupter to a vacuum terminal pad by attaching a silver-plated contact nut to a movable contact end of the vacuum circuit interrupter and using a rocker type contact assembly to connect the contact nut to the vacuum terminal pad. A rotating insulator of the disconnect switch drives a make/break mechanism that opens and closes the contacts inside the vacuum circuit interrupter. The rotating insulator turns a frame assembly so that an appropriate point in operation a trip point is reached and springs quickly rotate an actuator assembly driving the movable vacuum contacts at a high speed to the open or close position. The contact speed is approximately 7-10 milliseconds, which provides efficient circuit interruption or closure.

### FIELD OF THE INVENTION

This invention relates to an electrical power distribution circuit for electrical power distribution lines and, more particularly, to a high voltage disconnect switch.

### BACKGROUND OF THE INVENTION

Electrical power distribution circuits often include overhead electrical power distribution lines mounted upon poles by a wide variety of mounting structures. The poles may be forty to fifty feet high. The distribution lines require circuit disconnect switches at certain locations. Since such distribution lines commonly operate in a three-phased system, there are three associated lines which ordinarily must be disconnected and reconnected simultaneously. This requires group-operated switches.

Electric power distribution systems require switching for many reasons, including fault isolation, transferring load from one source to another, isolation of line segments for purpose of maintenance or new construction, and some instances for shedding loads. Three pole gang operated switches such as the switch disclosed in Bridges' U.S. Pat. No. 5,483,030 are a common low-cost manually operated switch for providing such switching capabilities. Another type of switch is disclosed in Dorsey et al., U.S. patent application Ser. No. 08/562,906, filed Nov. 27, 1995.

Conventional group operated disconnect switches use airbreak switches to disconnect and reconnect the lines. Particularly, a contact blade is moved either by manual actuation or automatic actuation relative to a jaw. Such airbreak switches operate satisfactorily, particularly in view of the fact that the switches tend to be operated infrequently. Nevertheless, such airbreak switches are exposed to the elements and may be more difficult to operate under certain environmental conditions, such as icing conditions, when subject to pollutants or being in corrosive environments.

With current reengineering of utility systems there is anticipated a need to switch group operated circuit disconnect apparatus more frequently for rerouting substations and the like. This may require multiple switching operations per day. Advantageously, these conditions must be met while retaining long life to the disconnect apparatus.

The present invention is directed to solving one or more of the problems discussed above in a novel and simple manner.

### SUMMARY OF THE INVENTION

In accordance with the invention, there is disclosed a high voltage disconnect switch using a vacuum circuit interrupter.

Broadly, in a group operated circuit disconnect apparatus for overhead electrical power lines including an operator controlling the apparatus, plural disconnect switches each comprise a vacuum circuit interrupter having a fixed contact end and a moveable contact end. A first terminal pad is electrically connected to the fixed contact end. A second terminal pad is electrically connected to the moveable contact end. A shaft is operatively driven by the operator. A tripping mechanism is operatively coupled to the shaft and to the moveable contact end. The tripping mechanism selectively operates the moveable contact end to actuate the vacuum circuit interrupter in response to rotation of the shaft.

More particularly, a vacuum circuit interrupter is mounted inside an insulating bushing. Current is transferred from a terminal pad through the vacuum circuit interrupter to a vacuum terminal pad by attaching a silver-plated contact nut to a movable contact end of the vacuum circuit interrupter and using a rocker type contact assembly to connect the contact nut to the vacuum terminal pad. A rotating insulator of the disconnect switch drives a make/break mechanism that opens and closes the contacts inside the vacuum circuit interrupter. The rotating insulator turns a frame assembly so that an appropriate point in operation a trip point is reached and springs quickly rotate an actuator assembly driving the movable vacuum contacts at a high speed to the open or close position. The contact speed is approximately 7-10 milliseconds, which provides efficient circuit interruption or closure.

Further features and advantages of the invention will be readily apparent from the specification and from the drawings.

### BRIEF DESCRIPTION OF THE DRAWINGS

FIG. 1 is a front elevation view of a group operated circuit disconnect apparatus including high voltage disconnect switches in accordance with the invention mounted on a pole;

FIG. 2 is a side elevation view of the apparatus shown in FIG. 1;

FIG. 3 is an enlarged side elevation view of the group operated disconnect apparatus of FIG. 1;

FIG. 4 is a partially cutaway top plan view of the high voltage disconnect switch in accordance with the invention;

FIG. 5 is a side view of the high voltage disconnect switch of FIG. 4;

FIG. 6 is a rear elevation view, with parts removed for clarity, showing current transfer components for the high voltage disconnect switch of FIG. 4;

FIG. 7 is a partial side elevation view, with parts removed for clarity, illustrating a rotary drive mechanism of the disconnect switch of FIG. 4;

FIG. 8 is a plan view of a frame assembly of the disconnect switch of FIG. 4;

FIG. 9 is a side elevation view of the frame assembly of FIG. 8;

FIG. 10 is a side elevation view of an actuator assembly of the disconnect switch of FIG. 4;

FIG. 11 is a plan view of the actuator assembly of FIG. 10;

FIG. 12 is a front elevation view of a rod end assembly of the disconnect switch of FIG. 4; and

FIG. 13 is a side elevation view of the rod end assembly of FIG. 12.

### DETAILED DESCRIPTION OF THE INVENTION

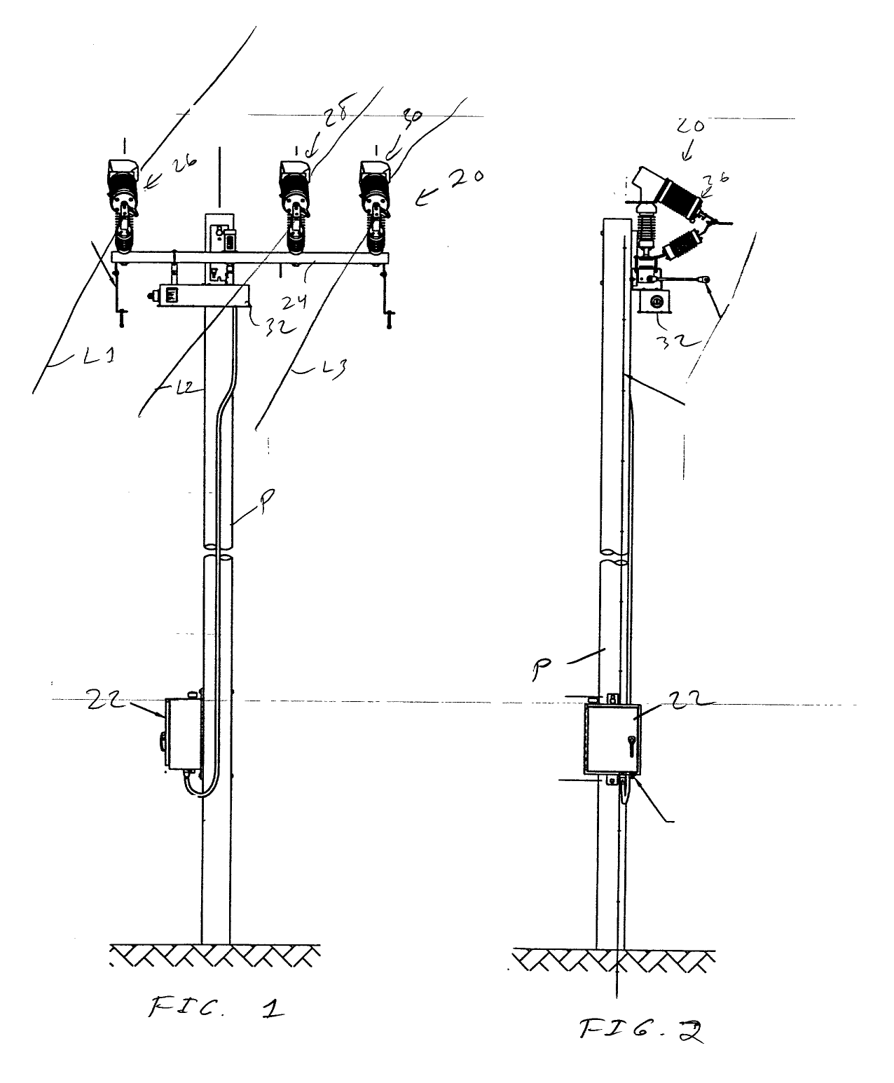

Referring to FIG. 1, overhead electrical power distribution lines L1, L2 and L3 are carried on a pole P by a group operated circuit disconnect apparatus 20. The disconnect apparatus 20 is operated in response to command signals from a switch control assembly 22 mounted to the pole P. The switch control assembly 22 develops the command signals based on user commands that originate either locally or remotely.

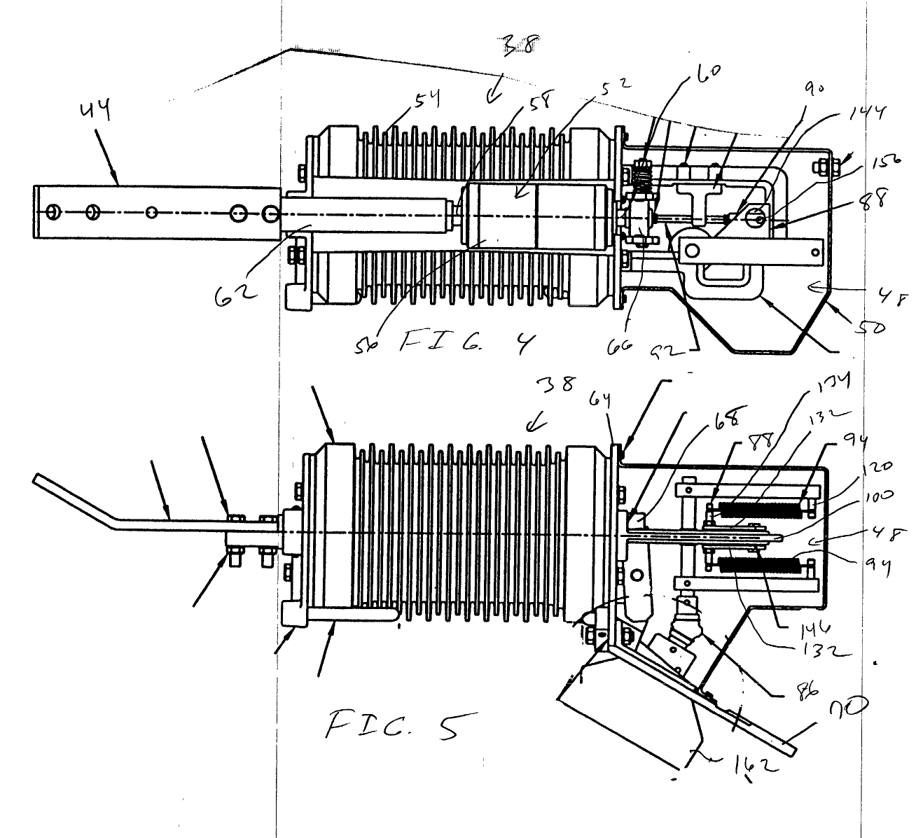

Referring also to FIGS. 2 and 3, the circuit disconnect apparatus 20 includes a base assembly 24, three disconnect switches 26, 28 and 30, respectively, mounted on the base assembly 24 and a motor assembly 32 mounted to the underside of the base assembly 24. The base assembly 24, motor assembly 32 and control assembly 22 may be as generally described in Dorsey et al., U.S. patent application Ser. No. 08/562,906, assigned to the assignee of the present invention, and the specification of which is hereby incorporated herein. As described in the referenced application, the motor assembly 32 is mechanically coupled with a transverse operation rod assembly (not shown herein) in the base assembly 24 so that simultaneous operation of the three disconnect switches 26, 28 and 30 is achieved by the motor assembly 32.

In accordance with the present invention, the three disconnect switches 26, 28 and 30 use high voltage disconnect switches 38 with vacuum circuit interrupters, as described more particularly below.

Referring particularly to FIG. 3, the first disconnect switch 26 is illustrated. The other disconnect switches 28 and 30 are identical in construction and are therefore not described in detail herein.

The disconnect switch 26 includes a fixed insulator 34, a rotating insulator 36 and the high voltage disconnect switch 38 in accordance with the invention. Particularly, the fixed insulator 34 is fixedly mounted at one end using a bracket 40 to the base assembly 24. A terminal bar support 42 mounts an opposite end of the fixed insulator 34 to a terminal pad 44 of the high voltage disconnect 38. The rotating insulator 36 is mounted on an upright shaft 46 which is driven by the drive system housed in the base assembly 24 in the manner described in the referenced application. As will be apparent, other drive systems may also be used to drive the rotating insulator 36, including both manually type operated drives and motor operated drives. An upper end of the rotating insulator 36 is operatively connected to a tripping mechanism 48, see FIGS. 4 and 5, enclosed in a housing 50. The tripping mechanism 48 is part of the high voltage disconnect switch 38.

Referring to FIGS. 4 and 5, the high voltage disconnect switch 38 is illustrated in greater detail. A vacuum circuit interrupter 52 is mounted inside a cylindrical cycloaliphatic bushing 54. The vacuum circuit interrupter 52 is in the form of a vacuum bottle 56 including movable vacuum contacts (not shown) therein. The area around the vacuum bottle within the bushing 54 is filled with a silicone dielectric gel. This increases the dielectric strength of the vacuum bottle 56. The vacuum circuit interrupter 52 includes a fixed contact end 58 and a movable contact end 60 at opposite ends thereof A conduction rod 62 extends through the bushing 54 and is secured so that an inner end of the rod 62 is in electrical contact with the fixed contact end 58. The rod 62 is attached externally to the terminal bar 44. Thus, the terminal bar 44 is in electrical contact with the fixed contact end 58.

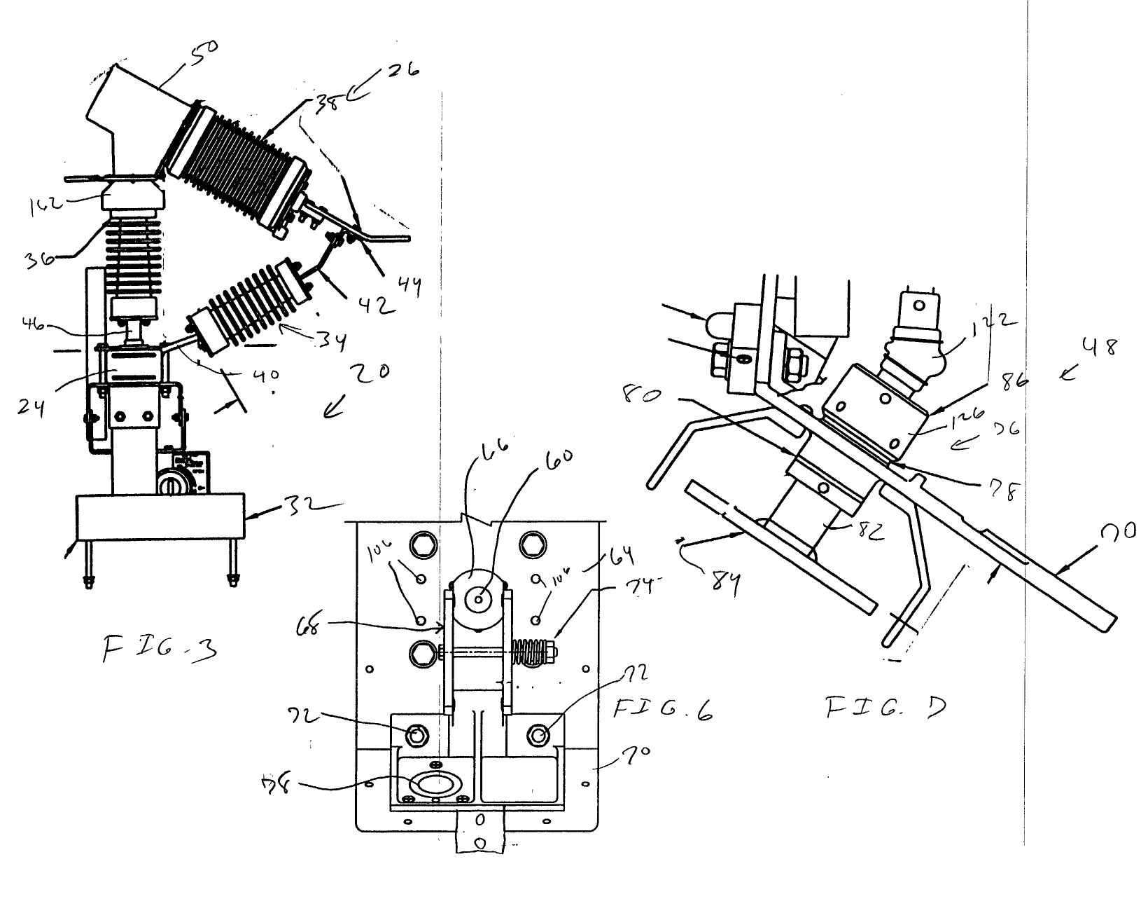

The vacuum bottle 56 is assembled to a cap 64 that seals the bushing 54. Current is transferred from the vacuum circuit interrupter moveable contact end 60 by attaching a silver-plated contact nut 66 to the movable contact end 60, see FIG. 6. A rocker type contact assembly 68 including silver rivets (not shown) connects the contact nut 66 to a vacuum terminal pad 70. The vacuum terminal pad 70 is connected to the cap 64 using threaded fasteners 72, as illustrated in FIG. 6. The contact assembly 68 includes a spring 74 to maintain tension between the contact assembly 68 and the contact nut 66 and the vacuum terminal 70 notwithstanding movement of the contact nut 66 in response to actuation motion by the tripping mechanism 48, as discussed below.

Referring to FIG. 7, the tripping mechanism 48 includes a rotary drive mechanism 76 driven by the rotating insulator 36, see FIG. 3. The vacuum terminal 70 includes a through opening 78, see FIG. 6, having a bearing 80 secured on its underside, see FIG. 7. A shaft 82 extends through the bearing 80 and is connected at a lower end to a flange 84 and at an upper end to a frame assembly 86. The flange 84 is operatively connected to the rotating insulator 36 for rotation therewith.

Referring back to FIGS. 4 and 5, the frame assembly 86 is operatively connected to an actuator assembly 88 which operatively engages a rod end assembly 90 connected via a threaded rod 92 to the contact nut 66 to transfer rotary drive motion from the rotating insulator 36, see FIG. 3, to selective linear movement of the threaded rod 92 and thus contact nut 66 to operate the vacuum circuit interrupter 52. Particularly, the rotating insulator 36 turns the frame assembly 86. At an appropriate point in the rotary operation, a trip point is reached. Two springs 94 very quickly rotate the actuator assembly 88 driving the movable contacts at a very high speed to the open or close position. The contact speed is approximately 7-10 milliseconds, which provides extremely efficient circuit interruption or closure.

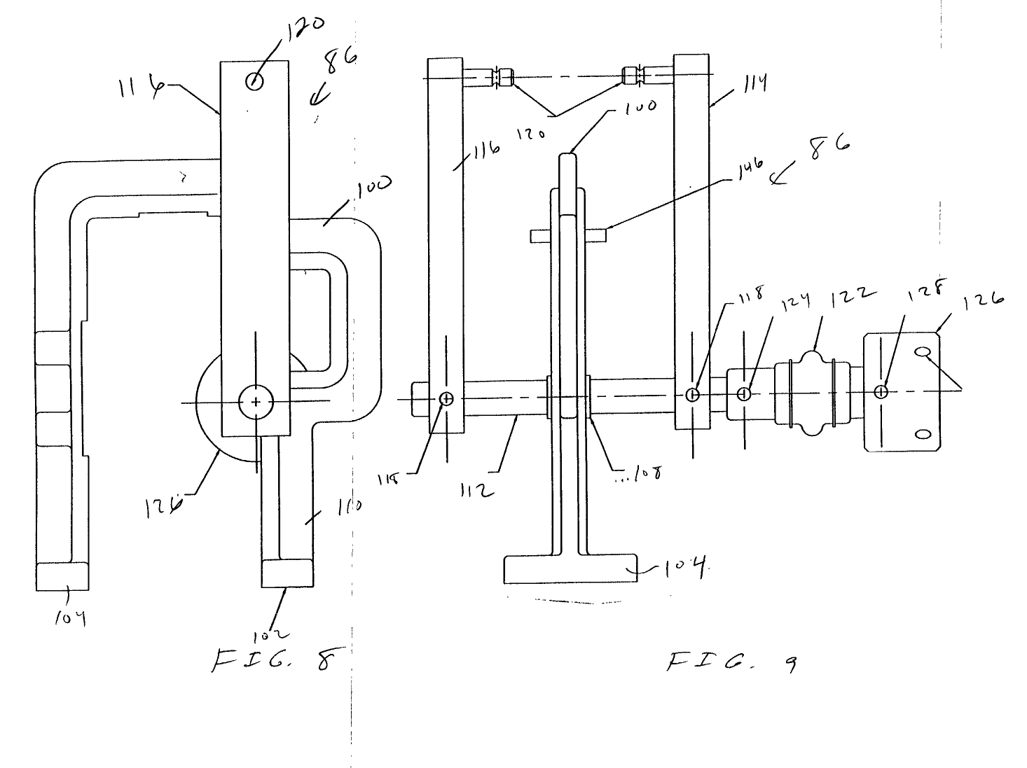

Referring to FIGS. 8 and 9, the frame assembly 86 is illustrated in detail. The frame assembly 86 includes a frame 100 of an irregular “P” shape having end feet 102 and 104 secured using bolts, not shown, to threaded openings 106 in the cap 64, see FIG. 6. A nylon bearing 108 passes through an opening (not shown) in a first leg 110 nearest the first foot 102. A shaft 112 extends through the bearing 108. A first lever arm 114 is fixedly connected to a near end of the shaft 112, while a second lever arm 116 is connected to a distal end of the shaft 112. Roll pins 118 secure the lever arms 114 and 116 to the shaft 112. Lever spring pins 120 extend toward one another from distal ends of the lever arms 114 and 116. A universal joint 122 is connected to the near end of the shaft 112 using a roll pin 124 an and opposite end of the universal joint 122 is connected to a ring 126 using a roll pin 128. Referring to FIG. 7, the ring 126 is operatively connected to the shaft 82 for rotation therewith. A hinge pin 146 is fastened to the frame 100.

Thus, as is apparent, rotary movement of the rotating insulator 36 rotates the shaft 112 through the universal joint 122 to rotate the lever arms 114 and 116.

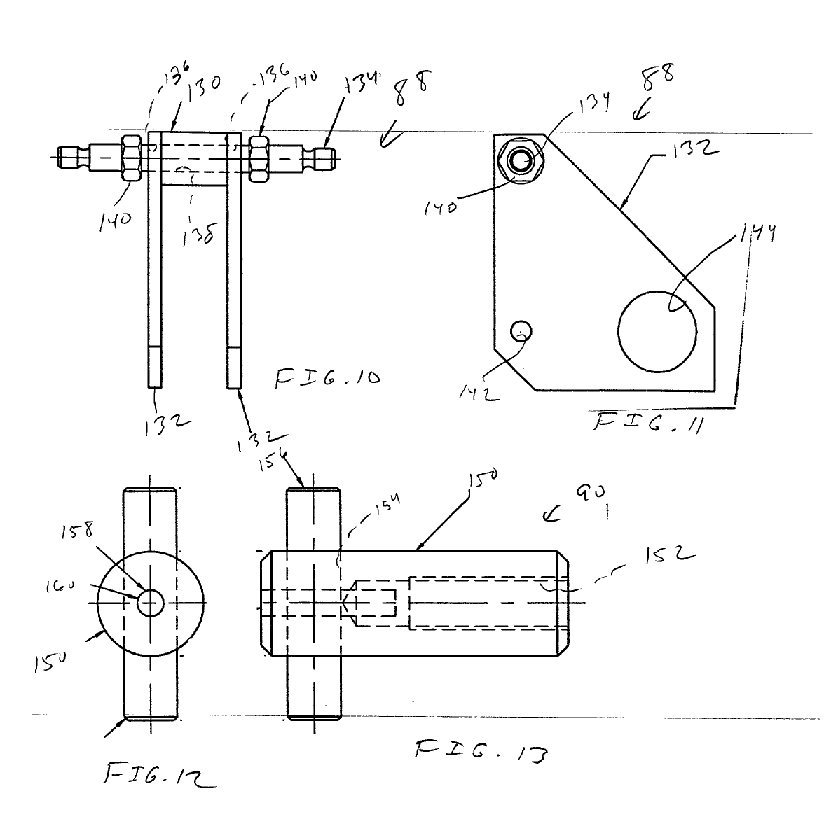

Referring to FIGS. 10 and 11, the actuator assembly 88 includes a spacer 130 disposed between first and second actuator plates 132. A lifter clamp rod 134 extends through openings 136 in the actuator plates 132 and a through opening 138 in the spacer. Lock nuts 140 maintain the actuator plates 132 in assembled relation separated by the spacer 130.

Each actuator plate 132 is generally triangular in configuration with generally “squared corners” and includes the clamp rod 134 proximate one corner thereof A relatively small hinge opening 142 is provided proximate a second corner while a relatively large actuator opening 144 is provided proximate a third corner.

Referring again to FIG. 5, the actuator assembly 88 is hingedly mounted to the frame assembly 86 with the actuator plates 132 sandwiching the frame 100 and the hinge pin 146 passing through the hinge openings 142. The springs 94 are attached at opposite ends to the frame assembly lever spring pins 120 and the actuator assembly clamp rod 134.

Referring to FIGS. 12 and 13, the rod end assembly 90 comprises a contact rod end 150 having a threaded counterbore 152 at an inner end and a transverse opening 154 at a distal end receiving a cross pin 156. A roll pin 158 is inserted in a distal end longitudinal opening 160 to secure the cross pin 156 in the transverse opening 154.

As shown in FIG. 4, the threaded rod 92 is threaded at one end into the vacuum circuit interrupter movable contact end 60 and at its distal end to the rod end assembly contact rod end threaded opening 152. As such, the cross pin 156 extends through the actuator plate actuator openings 144.

Owing to the described configuration, as the frame shaft 112 rotates, in response to rotary movement of the rotating insulator 36, the lever arms 114 and 116 are angularly moved inwardly and outwardly depending on direction of rotation. The tension springs 94 kick over at the center line to pivot the actuator assembly 88 about the hinge openings 142 and the actuator opening 144 selectively pulls or pushes the cross pin 156 of the rod assembly 90 to pull or push the rod 92 and thus open or close the vacuum circuit interrupter 52.

Referring to FIGS. 3 and 5, an ice shield 162 is mounted to an underside of the vacuum terminal 70 to cover the upper end of the rotating insulator 36.

Owing to the described configuration, the tripping mechanism 48 is enclosed in the housing 50 and the disconnect electrical contacts are contained within the vacuum bottle 56. This avoids problems due to icing conditions and other environmental factors such as pollutants and corrosive materials, such as salt water and the like. Moreover, the ice shield 162 results in any ice on the disconnect apparatus being placed in shear so that upon operation of the disconnect switch 32 the ice will easily break. Moreover, the vacuum interrupter 52 is adapted to hand switch capacitive and magnetized loads. Moreover, the tripping mechanism 48 is adapted to pull the vacuum circuit interrupter contacts open at a high speed and carry the current from the vacuum circuit interrupter 52 to the vacuum terminal pad 70. This construction allows for frequent switching operations and maintaining long life of the disconnect switch 32.

We claim:

1. In a group operated circuit disconnect apparatus for overhead electrical power lines including an operator controlling the apparatus, plural disconnect switches each comprising:
a vacuum circuit interrupter having a fixed contact end and a moveable contact end;
a first terminal pad electrically connected to the fixed contact end;
a second terminal pad electrically connected to the moveable contact end;
a shaft operatively driven by the operator; and
a tripping mechanism operatively coupled to the shaft and to the moveable contact end, the tripping mechanism selectively operating the moveable contact end to actuate the vacuum circuit interrupter in response to rotation of the shaft.

2. The disconnect switch of claim 1 wherein the tripping mechanism is enclosed in a housing.

3. The disconnect switch of claim 1 further comprising an insulating bushing enclosing the vacuum circuit interrupter.

4. The disconnect switch of claim 3 wherein the vacuum circuit interrupter is sealed in the bushing with a silicone dielectric gel.

5. The disconnect switch of claim 1 wherein the shaft is driven by a rotating insulator and further comprising an ice shield covering connection of the shaft to the rotating insulator.

6. The disconnect switch of claim 1 wherein the tripping mechanism pulls the vacuum circuit interrupter open at high speed in the range of about seven to tem milliseconds.

7. The disconnect switch of claim 1 wherein the tripping mechanism converts rotary motion of the shaft to linear motion to operate the movable contact end.

8. The disconnect switch of claim 7 wherein the tripping mechanism includes a spring operated actuator that trips over at a center line of rotary motion to operate the movable contact end.

9. The disconnect switch of claim 1 further comprising a rocker contact assembly electrically connected between the moveable contact end and the second terminal pad to electrically connect the moveable contact end to the second terminal pad.

10. The disconnect switch of claim 9 wherein the rocker contact assembly includes a spring to maintain between the moveable contact end and the rocker contact assembly and between the second terminal pad and the rocker contact assembly.

11. A group operated circuit disconnect apparatus for overhead electrical power lines comprising:
an operator controlling the disconcert apparatus; and
a plurality of disconnect switches each comprising a rotating insulator driven by the operator and a high voltage disconnect switch driven by the rotating insulator, each high voltage disconnect switch comprising
a vacuum circuit interrupter having a fixed contact end and a moveable contact end,
a first terminal pad electrically connected to the fixed contact end,
a second terminal pad electrically connected to the moveable contact end,
a shaft operatively driven by the rotating insulator, and
a tripping mechanism operatively coupled to the shaft and to the moveable contact end, the tripping mechanism selectively operating the moveable contact end to actuate the vacuum circuit interrupter in response to rotation of the shaft.

12. The disconnect apparatus of claim 11 wherein each tripping mechanism is enclosed in a housing.

13. The disconnect apparatus of claim 11 wherein each high voltage disconnect switch further comprises an insulating bushing enclosing each vacuum circuit interrupter.

14. The disconnect apparatus of claim 13 wherein each vacuum circuit interrupter is sealed in the bushing with a silicone dielectric gel.

15. The disconnect apparatus of claim 11 wherein each high voltage disconnect switch further comprises an ice shield covering connection of the shaft to the rotating insulator.

16. The disconnect apparatus of claim 11 wherein each tripping mechanism pulls the vacuum circuit interrupter open at high speed in the range of about seven to ten milliseconds.

17. The disconnect apparatus of claim 11 wherein each tripping mechanism converts rotary motion of the shaft to linear motion to operate the movable contact end.

18. The disconnect apparatus of claim 17 wherein each tripping mechanism includes a spring operated actuator that trips over at a center line of rotary motion to operate the movable contact end.

19. The disconnect apparatus of claim 11 wherein each high voltage disconnect switch further comprises a rocker contact assembly electrically connected between the moveable contact end and the second terminal pad to electrically connect the moveable contact end to the second terminal pad.

20. The disconnect apparatus of claim 19 wherein each rocker contact assembly includes a spring to maintain between the moveable contact end and the rocker contact assembly and between the second terminal pad and the rocker contact assembly.
